(19) United States
(12) Patent Application Publication
(10) Pub. No.: US 2013/0332428 A1
(43) Pub. Date: Dec. 12, 2013

(54) Online and Workload Driven Index Defragmentation

(71) Applicants: Vivek Ravindranath Narasayya, Redmond, WA (US); Hyunjung Park, Stanford, CA (US); Manoj Syamala, Issaquah, WA (US)

(72) Inventors: Vivek Ravindranath Narasayya, Redmond, WA (US); Hyunjung Park, Stanford, CA (US); Manoj Syamala, Issaquah, WA (US)

(73) Assignee: MICROSOFT CORPORATION, Redmond, WA (US)

(21) Appl. No.: 13/493,396

(22) Filed: Jun. 11, 2012

(51) Int. Cl. G06F 17/30

(52) U.S. Cl. 707/693; 707/E17.005

(57) ABSTRACT

The subject disclosure is directed towards defragmenting one or more ranges of a database index based upon actual usage statistics and policy. A range tracker tracks and uses statistics corresponding to actual I/O operations to determine whether the benefit of defragmenting a range sufficiently (based upon the policy) exceeds its cost. If so, the online range defragmenter automatically defragments the range in an online manner. The range tracker may be configurable to monitor less than all ranges of the index.

### BACKGROUND

In database management systems, decision support queries involve scanning large amounts of data. This data is typically stored in structures referred to as indexes, e.g., B-trees, and/or B+ trees. Typically when an index is created, the I/O (input/output) performance of queries that scan the index is good. However, as data is inserted, updated and deleted over time, an index can get fragmented.

One type of fragmentation is internal fragmentation, which occurs when leaf pages of an index are only partially filled, thus increasing the number of pages that need to be scanned to locate the queried data. Another type is external fragmentation, which occurs when the logical order of leaf pages in the index tree differs from the physical order of the pages, thereby increasing the number of disk seeks needed to locate the queried data.

In general, the I/O performance of queries depends significantly on fragmentation in the index, e.g., queries that scan an index may suffer significant degradation of I/O performance as a result of index fragmentation. Thus, defragmentation may be needed to help system performance.

The task of determining if an index needs to be defragmented is challenging for database administrators because contemporary database engines offer no support for quantifying the impact of defragmenting an index on query I/O performance. Further, database management systems only support defragmentation at the granularity of an entire index. This can be very restrictive, because defragmentation is an expensive operation.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which an online range defragmenter defragments one or more ranges of an index. A range tracker tracks and uses statistics corresponding to actual I/O operations to determine whether a benefit of defragmenting a range of an index sufficiently exceeds a cost of defragmenting the range. If so, the online range defragmenter automatically defragments the range in an online manner, that is, while allowing concurrent queries and updates to other ranges to proceed. In one aspect, the range tracker is configurable to monitor less than all ranges of the index.

In one aspect, defragmentation policy criteria may be used to determine whether the benefit sufficiently exceeds the cost. The defragmentation policy criteria may further include data (such as a maintenance window for deferring the defragmentation operation) that may be used in determining when to trigger a defragmentation operation on the range.

In one aspect, described is tracking statistics including actual I/O operations corresponding to index page nodes at an index level that references leaf node pages of the index. The statistics are used to determine a range of the index to defragment based upon benefit data corresponding to the actual I/O operations. Defragmenting of the range may be performed in an online operation that allows other ranges to be accessed with concurrent queries and updates.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components of an online range defragmentation system according to one example implementation.

FIG. 2 is a representation of a B+ tree index showing the tracking of range data at an index level above a leaf node level in the index.

FIG. 3 is a representation of online range defragmentation of a range corresponding to a set of pages according to one example implementation.

FIGS. 4A-4C comprise representations of range defragmentation of a range according to one example implementation.

FIG. 5 is a flow diagram showing some example steps that may be taken to determine whether to online defragment of a range according to one example implementation.

FIG. 6 is a block diagram representing an example non-limiting computing system or operating environment into which one or more aspects of various embodiments described herein can be implemented.

### DETAILED DESCRIPTION

Various aspects of the technology described herein are generally directed towards a workload driven and online index defragmentation functionality in a database system. In one aspect, the technology tracks the potential benefit of defragmenting an index on I/O performance at low overhead. Further, the technology provides the ability to defragment a range of a database index online, that is, a selected part of the index without locking the entire index. Still further, the technology deals with a cost/benefit tradeoff, as to how cost/benefit may be controlled in a policy driven manner, thereby enabling automatic workload driven index defragmentation resulting in reduced database administrator intervention.

More particularly, in one aspect, logical ranges of an index are identified, and the benefit and cost of defragmentation of each range are tracked at the granularity of each logical range. These benefits and costs are computed for the workload that executes on the system. Index defragmentation of a logical range is performed in an online manner, that is, with relatively minimal locking. A policy may be used to determine if and when online index defragmentation is to be triggered and for which logical ranges, e.g., when a determined benefit sufficiently exceeds a cost value.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and database technology in general.

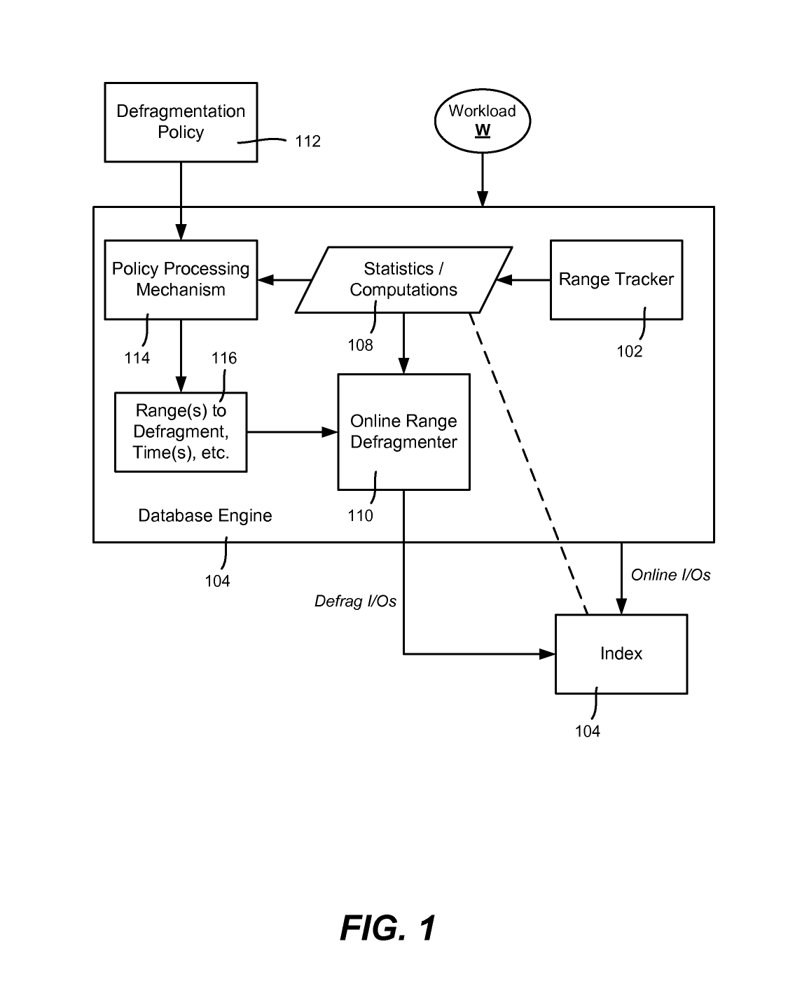

FIG. 1 exemplifies various components of one example implementation of an online and workload driven index defragmentation service. As represented in FIG. 1, a range tracker 102 (e.g., in a database engine 104) comprises a monitoring component that estimates the benefit of defragmenting an index 106 (or ranges of the index 106) for the queries that have executed on the system. In one aspect, the range tracker monitoring component estimates the reduction in the number of I/Os for a query that scans the index 106 or a range thereof that were to result if that index were to be defragmented. Such a “what-if” operation facilitates making an informed decision on whether an index/range should be defragmented. Note that only certain ranges need be monitored, e.g., monitoring of a range may be selective based upon actual (or possibly estimated) usage information.

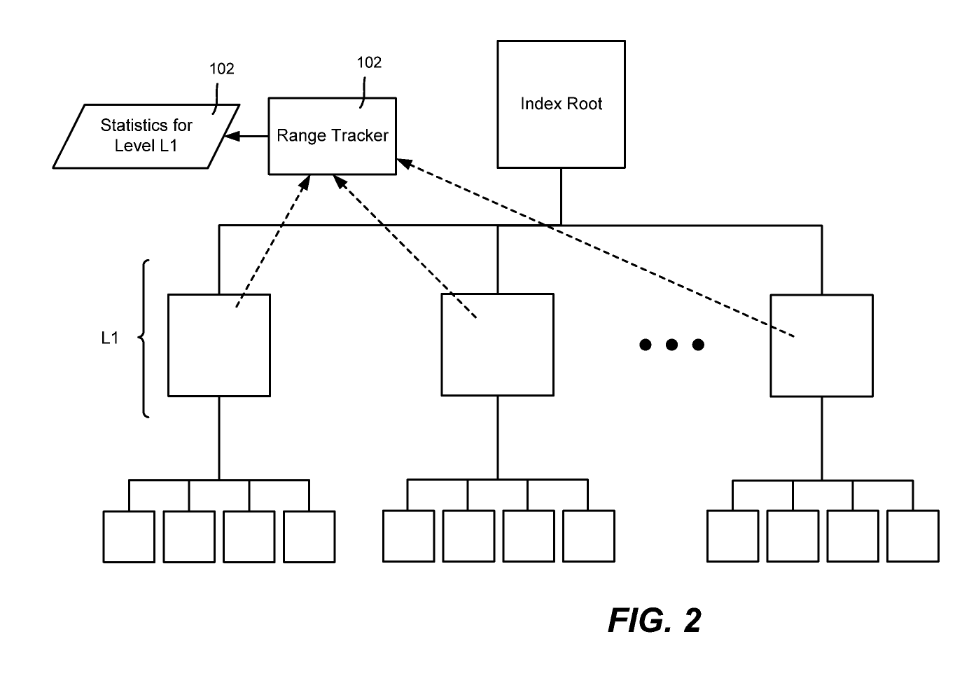

In one implementation, monitoring is performed with low overhead by piggybacking on execution of queries in the system. More particularly, the range tracker 102 gathers statistics 220 corresponding to actual I/Os based upon data tracked at the L1 level as represented in FIG. 2. Note that although in FIG. 2 (for simplicity) it appears that L1 is a direct child of the root, in actuality it is understood that there may be zero or more levels above L1 until reaching the root. Further, note that the pages at the L1 level map to the leaf node pages that are accessed in a scan via one or more I/O operations (or simply I/Os). The information as to the actual number of disk I/Os needed to complete a scan corresponding to a range is available from the database engine 104. Note that there are no actual I/Os when the corresponding data is in cache memory rather than on disk. Further, the number of I/Os that are needed to complete the same scan had the range been contiguous is able to be computed in a straightforward way. Thus, one way to compute the benefit of defragmenting a range is the actual I/O cost minus the computed I/O cost had that range been defragmented, that is, contiguous. Block 108 in FIG. 1 represents such statistics and computations made on those statistics.

The range tracker 102 subscribes for notifications of page splits, so that in the event an index page is split, the statistics may be adjusted. For example, the benefit data may be cleared and recomputed on the next scan, if any, that hits the appropriate page or pages.

In one aspect represented in FIG. 1, an online range defragmenter mechanism 110 for defragmenting a range of the index 104 is provided. Online refers to the ability to invoke the mechanism 110 in an online manner, e.g., with minimal locking, thereby allowing concurrent queries and updates to proceed without significant blocking; (note that the online range defragmenter may also be used offline). As will be understood, an advantage of such range level defragmentation is that most of the benefits of defragmentation for a query (or workload) often may be realized by only defragmenting a small part of the entire index. Range defragmentation is generally described in V. Narasayya and M. Syamala, “Workload Driven Index Defragmentation,” In ICDE, pp. 497-508, 2010.

In one aspect, a defragmentation policy 112 is provided for automatically deciding whether, and if so when, an index (or range of an index) is to be defragmented. The defragmentation policy 112, as processed by a policy processing mechanism 114, takes into account the benefit of defragmentation as well as the cost. Note that in FIG. 1, the policy processing mechanism 114 is shown as a separate component, however it is understood that the policy processing mechanism 114 may be incorporated into the range tracker 102 and/or the online range defragmenter mechanism 110; indeed, the components shown in FIG. 1 may be further combined and/or divided into sub-components.

In general, the defragmentation policy 112/policy processing mechanism 114 looks for “sufficient evidence” based on the workload W before triggering defragmentation of the index 104. The defragmentation policy 112 may be configured by a database administrator in different ways, e.g., to establish how aggressive or conservative the system is to be, whether defragmentation is to be deferred to a maintenance window (e.g., at night after normal working hours), and so forth.

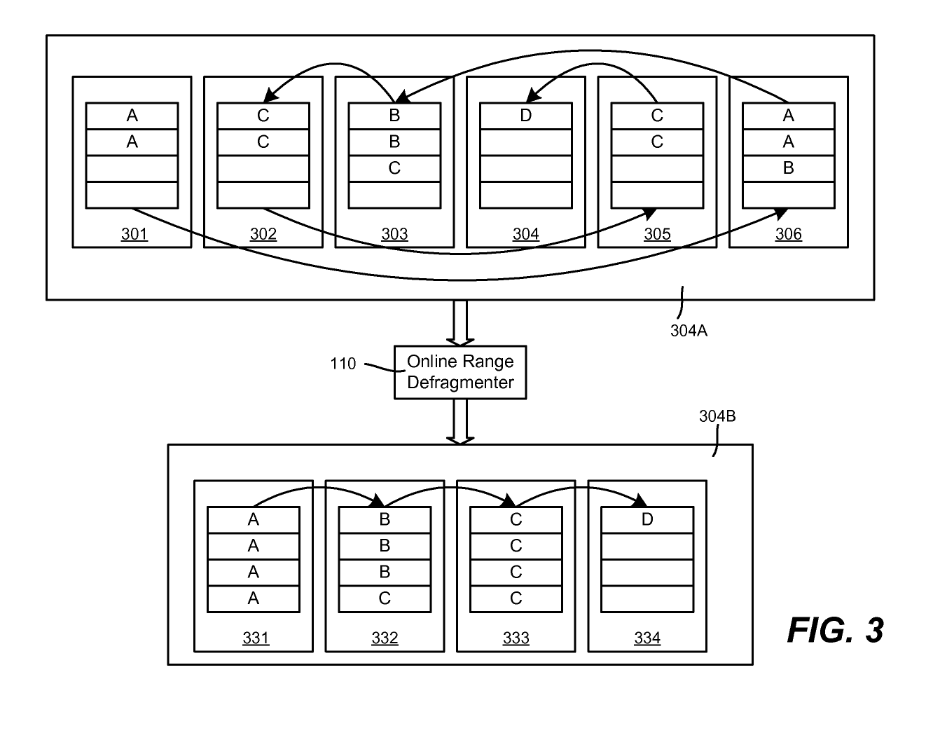

Turning to additional details, unlike rebuilding an entire index, online defragmentation of ranges fills unused holes in disk space or appends defragmented pages to disk space following the index. In a first, compaction phase, internal fragmentation is removed by moving rows across pages. For example, in FIG. 3, the two rows with value A from page 306 in the index (at state 304A) are moved to page 301, and so on during the compaction step. Thus the number of pages in the index is able to be reduced. In a second, phase, the pages that remain after the compaction step are rewritten to contiguous free pages 331-334 on the disk so that the logical order of pages in the index, (as shown by the index pages 331-334 at state 304B) agrees with the physical order of pages in the data file. Note that it is feasible to have a one-pass operation that removes internal and external fragmentation.

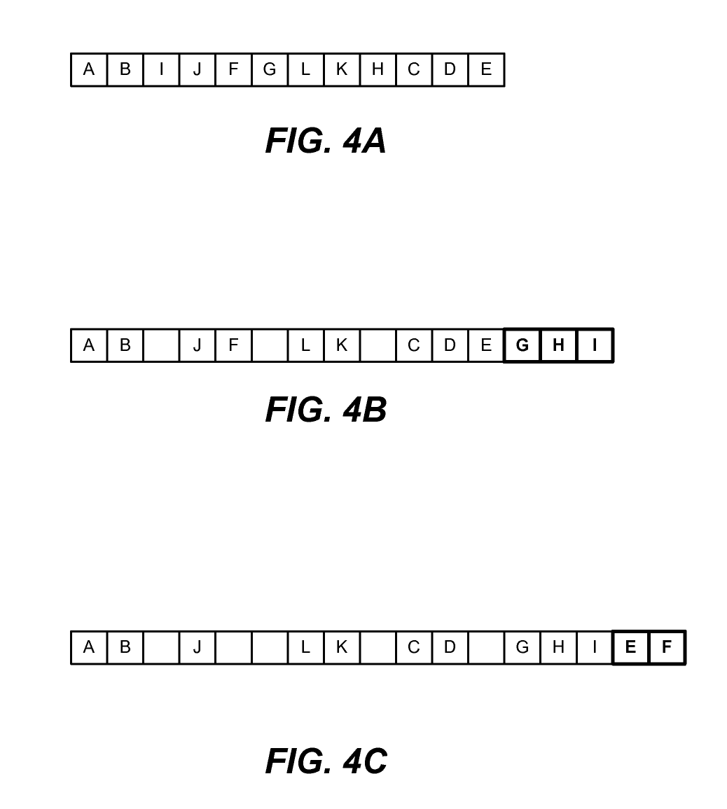

More particularly, as represented in FIGS. 4A-4C, the range defragmenter places a defragmented range at any contiguous free space that is large enough to accommodate the range. This may be determined by inspecting the free extent bitmap in the global allocation map (GAM) pages for example. If no such space is found, the range is placed at the end of file (whereby the file grows). Thus, the range of G, H and I in FIG. 4A are moved to the end of the file as shown (bolded) in FIG. 4B. To move a range comprising E and F, there are only single free space slots in FIG. 4B, and thus E and F are moved to the end of the file as shown (bolded) in FIG. 4C.

An Index range refers to those leaf node pages corresponding to an L1 page at which the statistics are kept. The online range defragmenter 110 is able to defragment a single index range or a set of index ranges. The cost of defragmenting a range R may be modeled using the following formula:

DefragCost(R)=k₁N_{R}+k₂N_{R}(1−CR(R))+k₃CR(R)N_{R}EF(R)

where the first two terms in the above formula represent the cost of removing internal fragmentation. This involves piggybacking on the scan of that range to detect the amount of internal and external fragmentation. The defragmentation cost thus depends on the compaction ratio CR(R) which depends on internal fragmentation and the degree of external fragmentation EF(I). The constants k1, k2, and k3 may be set by calibrating the cost model for a given system such as Microsoft® SQL Server®).

In one implementation, statistics are kept by tracking scans at the tree's L1 level corresponding to the indexes into the leaves, e.g., including the number of times each index is accessed during a scan. This avoids the need to track actual scanned ranges, which is very complex and computationally expensive.

Note that fragmentation may not be uniform across an entire index, as it is common to have updates that are skewed towards certain ranges of the indexes compared to other ranges. Thus, the fragmentation in the index can also be skewed. In such cases, defragmenting only the range (or ranges) with large fragmentation may be adequate. Moreover, the workload may be skewed, e.g., if most queries in the workload access a certain range of an index, then fragmenting that range may be sufficient.

One online workload driven approach to online index defragmentation is based upon the ability to quantify the impact of defragmenting the index on the I/O cost of a query. Because defragmenting an index is an expensive operation, this needs to be done without having to actually defragment the index and execute the query. Thus, described herein is a “what-if” analysis, which for example may be implemented for access via an API in a database management system. In the event that the full index is defragmented, the reduction in the number of I/Os for a range scan query Q if index I is fully defragmented as Benefit(Q, I); for a set of ranges R, the benefit is denoted by Benefit(Q, I, R).

When the range R is defragmented, the benefit of defragmenting the range for a scan query Q is the reduction in the number of I/Os for Q if the range is defragmented, i.e. Benefit(Q, R)=NumIOs(Q,R)−NumIOsPostDefrag(Q, R), where NumIOs(Q,R) is the number of I/Os required to execute the range scan Q, and NumIOsPostDefrag(Q,R) is the number of I/Os over the defragmented range. To compute each of the terms efficiently, i.e. without actually defragmenting the range or executing Q, an estimate of the number of I/Os for a range scan query is computed.

Due to the semantics of the defragmentation operation, once a range is defragmented, the range has no internal or external fragmentation. Thus, estimating NumIOs(Q, Defrag(R)) needs to estimate the number of pages in the range after defragmentation. For this purpose, when the data pages in any range are scanned, the fullness of the data pages may be used for the estimate.

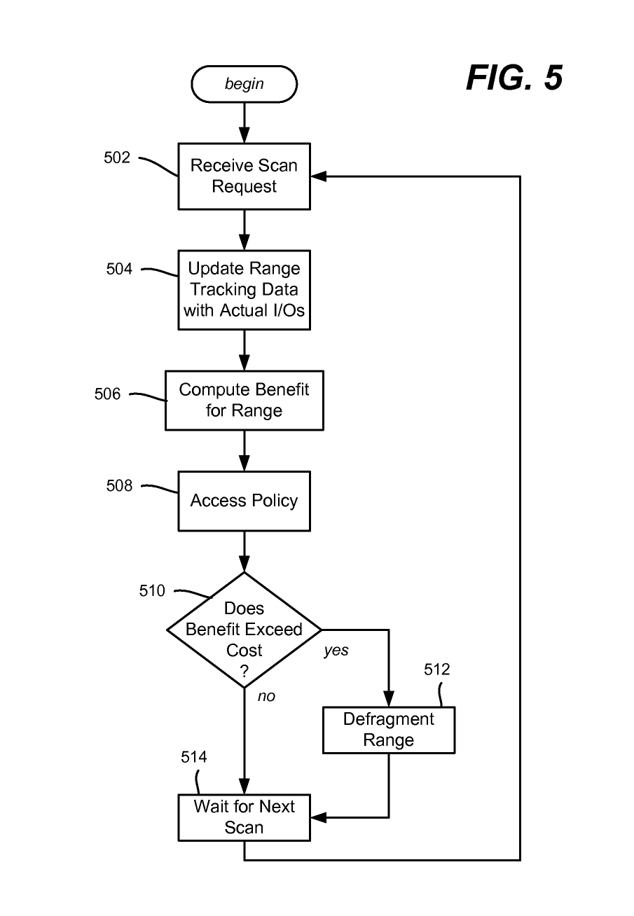

FIG. 5 is a flow diagram showing some example steps used in determining whether to online defragment a range, beginning at step 502 where a scan request is received that corresponds to one or more index pages. Step 504 updates the range tracking data for the relevant index pages, based on the actual I/Os used in the scan.

Step 506 represents determining the benefit for a range, e.g., the number of actual I/Os needed versus the hypothetical computed number of how many I/Os needed had the range been defragmented. Step 508 accesses the policy criteria to determine whether to defragment the range, e.g., based in part on whether the benefit sufficiently exceeds the cost. Note that the policy may specify that the defragmentation of a range is to be deferred, e.g., only defragment a range after normal working hours, and so forth. The cost data may be computed as described above. Also note that step 508 may be bypassed, such as if the benefit is zero, which occurs when a range is already defragmented/contiguous.

Step 510 evaluates whether the benefit sufficiently exceeds the cost as determined via the policy data. If so, step 512 is executed to defragment the range. Step 514 represents waiting for the next scan; note that many scans may be received in parallel, and thus any of the steps of FIG. 5 may be performed in parallel for other scans.

### Example Computing Environment

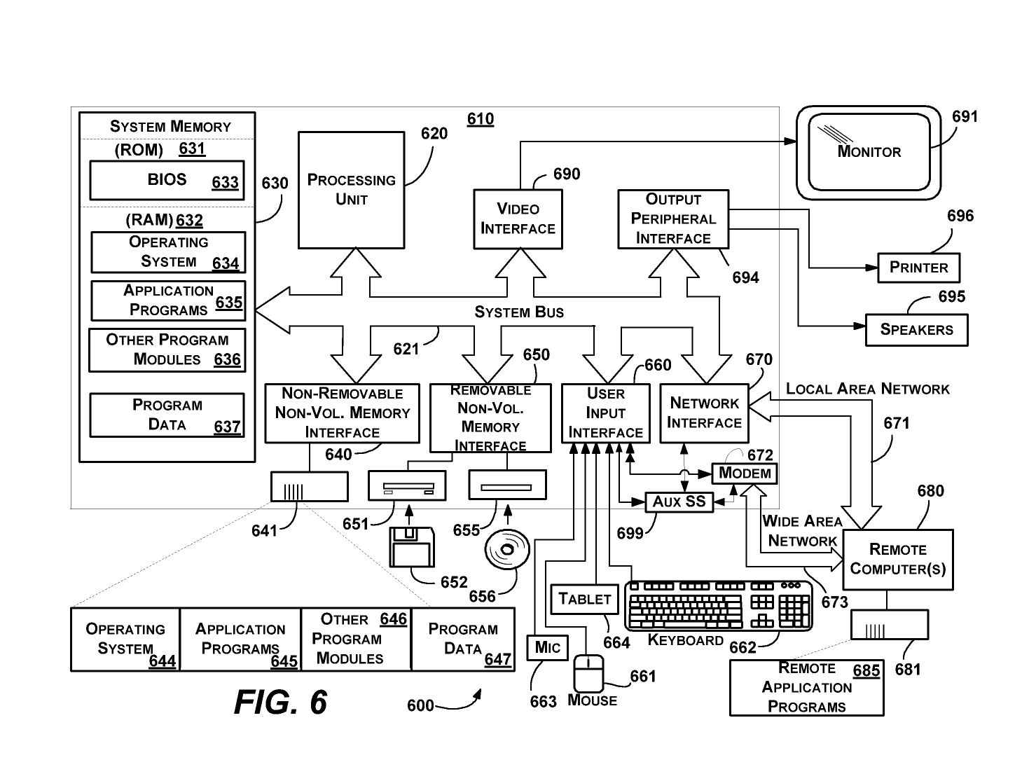

FIG. 6 illustrates an example of a suitable computing and networking environment 600 into which the examples and implementations of any of FIGS. 1-5 may be implemented, for example. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the example operating environment 600.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an example system for implementing various aspects of the invention may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media can be any available media that can be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 646 and program data 647. Note that these components can either be the same as or different from operating system 634, application programs 635, other program modules 636, and program data 637. Operating system 644, application programs 645, other program modules 646, and program data 647 are given different numbers herein to illustrate that, at a minimum, they are different copies. A user may enter commands and information into the computer 610 through input devices such as a tablet, or electronic digitizer, 664, a microphone 663, a keyboard 662 and pointing device 661, commonly referred to as mouse, trackball or touch pad. Other input devices not shown in FIG. 6 may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel can be physically coupled to a housing in which the computing device 610 is incorporated, such as in a tablet-type personal computer. In addition, computers such as the computing device 610 may also include other peripheral output devices such as speakers 695 and printer 696, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660 or other appropriate mechanism. A wireless networking component 674 such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are examples and other means of establishing a communications link between the computers may be used.

An auxiliary subsystem 699 (e.g., for auxiliary display of content) may be connected via the user interface 660 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A system comprising, an online range defragmenter configured to defragment one or more ranges of an index, and a range tracker, the range tracker configured to use statistics corresponding to actual I/O operations to determine whether a benefit of defragmenting a range sufficiently exceeds a cost of defragmenting the range, and if so, to identify the range for defragmentation.

2. The system of claim 1 wherein the online range defragmenter is configured to automatically defragment the range while allowing concurrent queries and updates to other ranges to proceed.

3. The system of claim 1 further comprising a policy that specifies one or more defragmentation policy criteria, including for use in determining whether the benefit sufficiently exceeds the cost.

4. The system of claim 1 further comprising a policy that specifies one or more defragmentation policy criteria, including for use in determining whether to defer a defragmentation operation on the range.

5. The system of claim 1 wherein the range tracker is further configured to monitor less than all ranges of the index.

6. The system of claim 1 wherein the benefit for a range is based at least in part upon a number of actual I/O operations compared to a computed number of I/O operations had the range been defragmented.

7. The system of claim 1 wherein the cost of defragmenting the range is determined based at least in part upon usage of the range.

8. The system of claim 1 wherein the statistics correspond to I/O operations detected for an index node page level above a leaf node level.

9. The system of claim 1 wherein the index comprises a B+ tree or a B tree.

10. The system of claim 1 wherein the range tracker is configured to receive a notification that a page is split and in response, to adjust the statistics corresponding to the page that was split.

11. A method comprising, tracking statistics including actual I/O operations corresponding to index page nodes at an index level that references leaf node pages of the index, using the statistics to determine a range of the index to defragment based upon benefit data corresponding to the actual I/O operations, and defragmenting the range in an online operation that allows other ranges to be accessed with concurrent queries and updates.

12. The method of claim 11 wherein using the statistics to determine the range comprises evaluating the benefit data along with cost data against one or more defragmentation policy criteria.

13. The method of claim 11 further comprising determining the benefit for a range based at least in part upon a number of actual I/O operations corresponding to the range and a computed number of I/O operations had the range been defragmented.

14. The method of claim 11 wherein tracking statistics comprises selectively determining only a subset of ranges to monitor.

15. The method of claim 11 further comprising receiving a notification that a page is split, and in response, adjusting the statistics for the page that was split.

16. A system comprising:
a range tracker configured to track statistics corresponding to actual I/O operations of index nodes that provide indexes into leaf nodes of an index, the range tracker further configured to the determine benefit data of defragmenting a range based at least in part on the statistics;
a policy processing mechanism configured to determine whether to defragment the range based at least in part on the benefit data and one or more defragmentation policy criteria; and
an online range defragmenter configured to defragment the range based upon a determination of the policy mechanism.

17. The system of claim 16 wherein the one or more defragmentation policy criteria comprises cost data, and wherein the policy mechanism determines whether to defragment the range based at least in part upon the benefit data and the cost data.

18. The system of claim 16 wherein the one or more defragmentation policy criteria include data by which the policy mechanism determines whether to defer defragmentation of the range.

19. The system of claim 16 wherein the range tracker is further configured to monitor less than all ranges of the index.

20. The system of claim 16 wherein the benefit data for a range is based at least in part upon a number of actual I/O operations compared to a computed number of I/O operations had the range been defragmented.
